(19) United States
(12) Patent Application Publication
(10) Pub. No.: US 2026/0181430 A1
(43) Pub. Date: Jun. 25, 2026

(54) METHODS AND SYSTEMS FOR DETERMINING CHANNEL STATUS BASED ON MEASUREMENTS

(71) Applicant: InterDigital Patent Holdings, Inc., Wilmington, DE (US)

(72) Inventors: Fumihiro Hasegawa, Westmount (CA); Yugeswar Deenoo Narayanan Thangaraj, Chalfont, PA (US); Moon IL Lee, Melville, NY (US); Shahab Hamidi-Rad, Sunnyvale, CA (US); Dylan Watts, Montreal (CA); Patrick Tooher, Montreal (CA)

(73) Assignee: InterDigital Patent Holdings, Inc., Wilmington, DE (US)

(21) Appl. No.: 18/989,752

(22) Filed: Dec. 20, 2024

(51) Int. Cl. H04W 24/08

(52) U.S. Cl. CPC H04W 24/08

(57) ABSTRACT

A wireless transmit/receive unit (WTRU) may be configured to receive a request to determine a line-of-sight (LOS) indicator. The WTRU may receive a positioning reference signal (PRS). The WTRU may receive sounding reference signal (SRS) configuration information from a network. The SRS configuration information may include an SRS configuration and/or SRS measurements. The WTRU may determine the LOS indicator based on the PRS that it received and/or the SRS measurements. The WTRU may also determine a quality indicator associated with the LOS indicator. The WTRU may report the LOS indicator and the quality indicator to the network.

### BACKGROUND

Various positioning techniques may be employed by devices operating in cellular systems. Uplink (UL), downlink (DL), and/or combinations of UL and DL positioning may be used.

A “DL positioning method” may refer to any positioning method that uses downlink reference signals, such as positioning reference signals (PRSs). The WTRU may receive multiple reference signals from one or more transmission points (TPs) and measure DL reference signal timing difference (RSTD) and/or reference signal received power (RSRP). Examples of DL positioning methods are DL-angle of departure (AoD) or DL-time difference of arrival (TDOA) positioning.

A “UL positioning method” may refer to any positioning method that uses uplink reference signals such as sounding reference signals (SRSs) for positioning. The WTRU transmits SRS to multiple reception points (RPs) and the RPs measure the UL relative time of arrival (RTOA) and/or RSRP. Examples of UL positioning methods are UL-TDOA or UL-angle of arrival (AoA) positioning.

A “DL & UL positioning method” may refer to any positioning method that uses both uplink and downlink reference signals for positioning. In examples, a WTRU transmits SRS to multiple transmission/reception points (TRPs) and gNB measures receive (Rx)-transmit (Tx) time difference which is calculated based on the time of arrival of DL reference signal (RS) (e.g., PRS). The gNB can measure RSRP for the received SRS. The WTRU measures Rx-Tx time difference for PRS transmitted from multiple TRPs. The WTRU can measure RSRP for the received PRS. The Rx-TX difference and possibly RSRP measured at WTRU and gNB are used to compute round trip time. “UE Rx-Tx time difference” refers to the difference between arrival time of the reference signal transmitted by the TRP and transmission time of the reference signal transmitted from the WTRU. An example of DL & UL positioning method is multi-round trip time (RTT) positioning.

### SUMMARY

A wireless transmit/receive unit (WTRU) may request for sounding reference signal (SRS) measurements from a network entity (e.g., a location management function (LMF)). The WTRU may request for SRS transmission from another positioning reference unit (PRU) and/or another WTRU. The WTRU may request SRS measurements associated with an SRS transmission made by a PRU or another WTRU. The WTRU may receive positioning reference signals (PRS) and/or SRSs measurements made by another PRU, WTRU, and/or transmission/reception point (TRP). The SRS measurements may correspond to the SRS transmitted by the PRU. The WTRU may determine a line-of-sight (LOS) or non-line-of-sight (NLOS) indicator based on PRS measurements and/or SRS measurements. The WTRU may determine associated quality indicators for the LOS and/or NLOS indicators. The WTRU may send a report indicating the LOS and/or NLOS indicators, the associated quality indicators, and or an indication of one or more measurements (e.g., PRS, SRS) used to determine the LOS/NLOS indicators.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow chart showing an example of using an AIML model to obtain WTRU location.

FIG. 3 is a system diagram illustrating an example of a WTRU receiving PRS and a report of SRS measurements.

FIG. 4 is a system diagram illustrating an example of a WTRU reporting an LOS indicator to a location management function (LMF).

FIG. 5 is a flow call showing an example of an exchange of signals between the WTRU and network (e.g., LMF, gNB).

FIG. 6 is a system diagram illustrating an example of a WTRU receiving PRS and a report of PRS and SRS measurements, where some measurements originate from a PRU.

FIG. 7 is a flow call showing an example of an exchange of signals between a, WTRU, PRU, gNB and an LMF.

### DETAILED DESCRIPTION

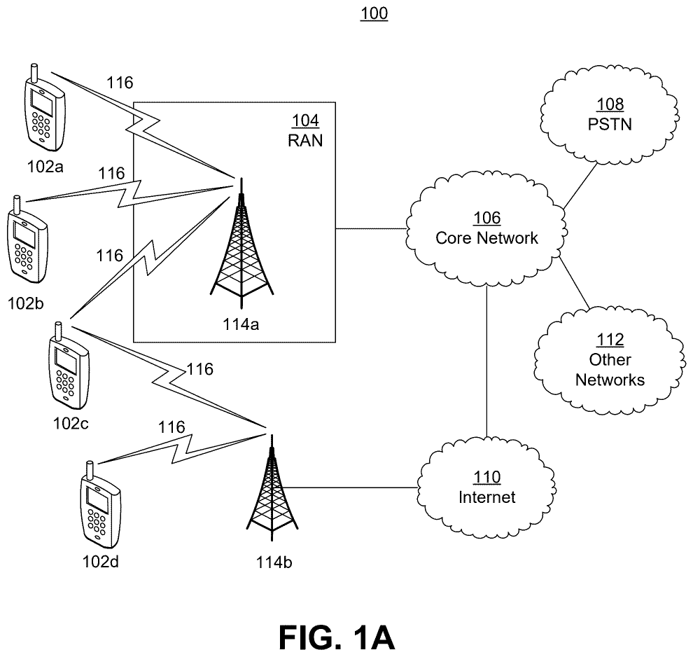

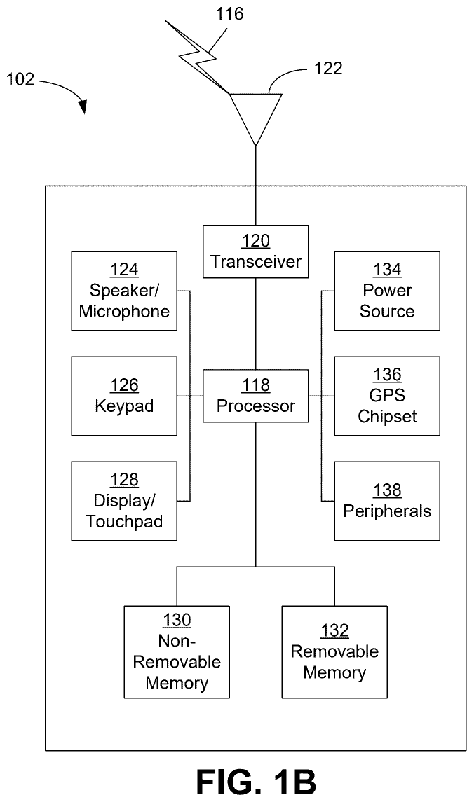

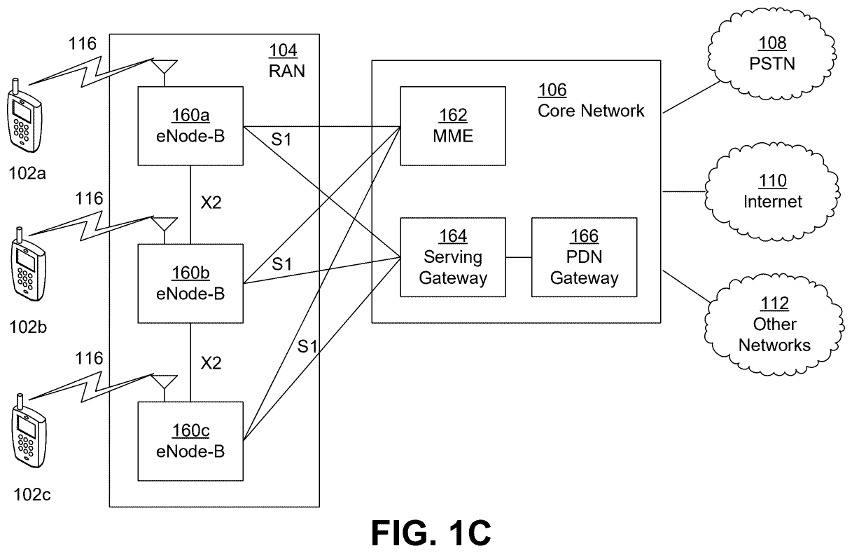

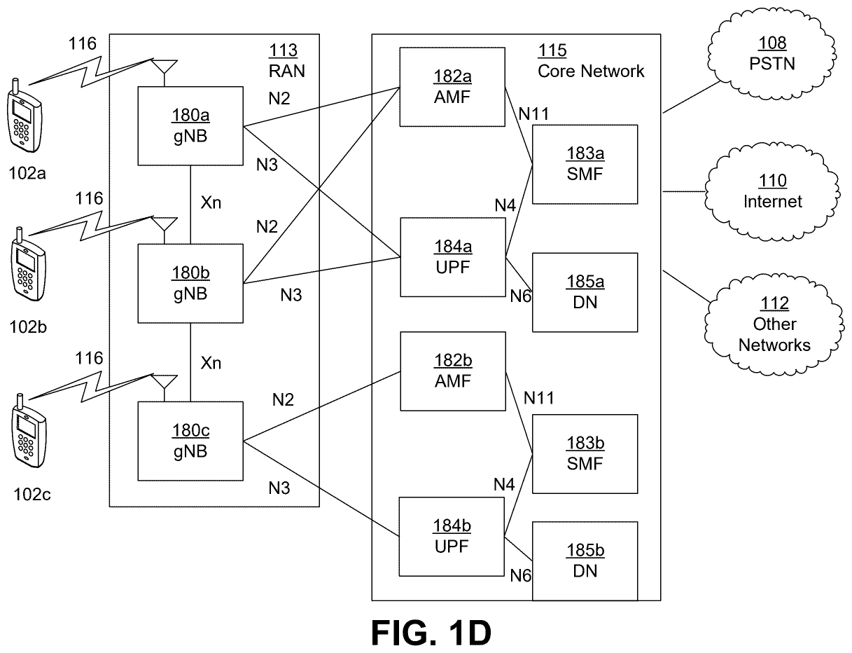

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102.

The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11 af and 802.11 ah. The channel operating bandwidths, and carriers, are reduced in 802.11 af and 802.11 ah relative to those used in 802.11n, and 802.11ac. 802.11 af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11 ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment.

The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An artificial intelligence/machine learning (AIML) model is trained, during a training phase, using measurements obtained from received downlink (DL)-reference signal (RS) and ground truth (e.g., WTRU locations). When the WTRU uses the trained AIML model, the received DL-RS should be transmitted from the network under the same condition as in the training phase. Otherwise, inconsistency compared to the training phase can occur. This can make the outcome of the AIML model not accurate or reliable.

General WTRU behavior is discussed herein. A WTRU may send a request to the network for configuration (e.g., DL-RS configurations, UL-RS configurations). In examples, the WTRU may send the request using a physical uplink shared channel (PUSCH), a physical uplink control channel (PUCCH), an uplink control information (UCI), a media access control-control element (MAC-CE), a radio resource control (RRC) message, and/or an LTE positioning protocol (LPP) message. The request from the WTRU may include configurations of a measurement gap, a DL-RS processing window and/or a window for transmission of UL-RS.

The WTRU may send an acknowledgement message in PUSCH or PUCCH for a grant received from the network.

WTRU behavior may be conditional. One or more than one conditions/criteria can be used in a combination. The WTRU may be configured with more than one conditions and associated WTRU behavior. The WTRU may determine which behavior the WTRU will use based on the applicable conditions.

The WTRU can measure DL-RS inside or outside of an active BWP. The WTRU may transmit UL-RS inside or outside of the active BWP.

The WTRU may be preconfigured with parameters (e.g., measurement gaps, DL-RS processing windows, DL-RS configurations, UL-RS configurations) via a semi-static message (e.g., LPP, RRC).

The WTRU may report measurements or configuration parameters in a semi-static message (e.g., LPP, RRC) and/or a dynamic message (e.g., UCI, MAC-CE).

Actions that the WTRU determines to take may be configured by the network. For example, the WTRU may be configured with a rule. According to the rule, the WTRU may determine to take an associated action.

In addition to the measurements made on DL-RS, the WTRU may include one or more of the following cell-related measurements: SSB RSRP from the serving cell with corresponding cell ID, SSB RSRP from the neighboring cell(s) with corresponding cell ID(s), RSRP of CSI-RS with CSI-RS resource ID, and/or RSRP of DM-RS.

A “network” may include network functions (NFs) such as an AMF or LMF. A “network” may also include entities such as a gNB and/or NG-RAN.

The terms “pre-configuration” and “configuration” may be used interchangeably herein. The terms “non-serving gNB” and “neighboring gNB” may be used interchangeably herein. The terms “gNB” and “TRP” may be used interchangeably herein. The terms “DL-RS” or “DL-RS resource” may be used interchangeably herein. The terms “DL-RS (s)” or “DL-RS resource(s)” may be used interchangeably herein. The aforementioned “DL-RS(s)” or “DL-RS resource(s)” may belong to the same or different DL-RS resource sets.

The terms “measurement gap” or “measurement gap pattern” may be used interchangeably herein. A “measurement gap pattern” may include parameters such as measurement gap duration, measurement gap repetition period, or measurement gap periodicity.

An LMF is a non-limiting example of a node or entity (e.g., network node or entity) that may be used for or to support positioning or sensing. Any other node or entity (e.g., an NF) may be substituted for LMF in the embodiments discussed herein.

The WTRU may receive one or more preconfigured threshold(s) from the network (e.g., LMF, gNB).

A line-of-sight (LOS) indicator may be hard (e.g., 1 or 0) or soft indicator (e.g., 0, 0.1, 0.2 . . . , 1). A LOS indicator may indicate the likelihood of the presence of an LOS path between a transmission/reception point (TRP) and a WTRU or along a DL-RS. For example, the WTRU may receive a request from the network to report an LOS indicator for the DL-RS. The WTRU may determine the LOS indicator for the DL-RS based on measurements. The determined LOS indicator may be associated with AoD or AoA of the DL-RS. The LOS indicator can be associated with a TRP or positioning reference signal (PRS) resource ID (e.g., index). The WTRU may receive the LOS indicator from the network per TRP or resource ID. Additionally, or alternatively, the WTRU may determine the LOS indicator per TRP or resource ID based on measurements. Similarly, the non-line-of-sight (NLOS) indicator indicates likelihood of the presence of an NLOS path between a TRP and a WTRU or along a DL-RS.

The terms “identifier,” “ID,” and “index” may be used interchangeably herein. The terms “training” and “data collection” may be used interchangeably herein. The terms “SRS,” “SRSp” or “SRS for positioning may be used interchangeably herein. The terms “WTRU-side condition,” “WTRU condition,” or “WTRU implementation” may be used interchangeably herein.

A WTRU location may be expressed in terms of units such as altitude, latitude, geographic coordinates, and/or local coordinates, for example.

A timestamp may be indicated by an absolute time, or a relative time (e.g., in seconds) compared to a reference time, SFN, slot index, frame index, subframe index and/or symbol index. Examples of “absolute time” include UTC time, GNSS time, locally defined absolute time (e.g., LTE or NR Time).

A WTRU may receive configurations for a time window. Configurations for a time window may indicate a duration (e.g., expressed in terms of seconds, number of symbols, number of slots, number of frames, number of subframes), a start and/or end time (e.g., expressed in terms of absolute time, system time, relative time with respect to a reference time indicated by the network or determined by the WTRU, SNF index, slot index, symbol index, frame index, subframe index). The WTRU may receive a set of one or more configurations of a time window, where each configuration of the set of configurations is associated with an index. The time window can be initiated with a trigger sent by the network. For example, the WTRU may receive a command (e.g., DCI) to initiate an indicated time window, indicated via the configuration index. The WTRU may determine to initiate the time window after a configured duration after reception of the command (e.g., N symbols, N slots, N frames, N seconds). The WTRU may receive an activation or deactivation command (e.g., DCI, MAC-CE) to activate or deactivate the time window, respectively, from the network.

Configurations for reference signals (RS) are discussed herein. In examples, the WTRU may receive DL-RS and/or UL-RS (e.g., SRS) configurations for positioning purposes from the network (e.g., LMF). The LMF may forward PRS configurations and/or SRS configurations to the gNB so that the gNB can schedule PRS transmission or SRS reception at the TRP, TP and/or RP.

Configurations for DL-RS are discussed herein. In examples, a DL-RS configuration may include one or more of the following parameters: a number of symbols, a transmission power, a number of DL-RS resources included in DL-RS resource set, a muting pattern for DL-RS (e.g., the muting pattern may be expressed via a bitmap), a periodicity, a type of DL-RS (e.g., periodic, semi-persistent, or aperiodic), a slot offset for periodic transmission for DL-RS, a vertical shift of DL-RS pattern in the frequency domain, a time gap during repetition, a repetition factor, resource element (RE) offset, a comb pattern, a comb size, a spatial relation (e.g., with respect to other DL-RSs or UL RS such as SRS for positioning purpose), quasi co-location (QC)L information (e.g., QCL target, QCL source) for DL-RS, a number of TRPs, an Absolute Radio-Frequency Channel Number (ARFCN), a subcarrier spacing, an expected RSTD, an uncertainty in expected RSTD, a start Physical Resource Block (PRB), a bandwidth, a bandwidth part (BWP) identifier (ID), a number of frequency layers, a start/end time for DL-RS transmission, an on/off indicator for DL-RS, a TRP ID, a DL-RS ID, a cell ID, a global cell ID, and/or an applicable time window. The WTRU may apply a DL-RS configuration under a condition that the current time is within the applicable time window. “ID” may be used interchangeably with “index.” Examples of DL-RS include CSI-RS, PTRS, PRS, TRS, and SSB.

Configurations for UL-RS are discussed herein. In examples, UL-RS or SRS configuration may include one or more of: a resource ID; comb offset values, cyclic shift values; a start position in the frequency domain; a number of UL-RS symbols; a shift in the frequency domain for UL-RS; a frequency hopping pattern; a type of UL-RS (e.g., aperiodic, semi-persistent or periodic); a sequence ID used to generate UL-RS, or other IDs used to generate UL-RS sequence; a spatial relation information, indicating which reference signal (e.g., DL RS, UL RS, CSI-RS, SRS, DM-RS) or SSB (e.g., SSB ID, cell ID of the SSB) the UL-RS is related to spatially where the UL-RS and DL RS may be aligned spatially; QCL information (e.g., a QCL relationship between UL-RS and other reference signals or SSB); QCL type (e.g., QCL type A, QCL type B, QCL type C, QCL type D); resource set ID; list of UL-RS resources in the resource set; transmission power related information; pathloss reference information, which may contain index for SSB, CSI-RS or DL-RS; periodicity of UL-RS transmission; bandwidth; carrier component ID; and/or spatial information such as spatial direction information of UL-RS transmission (e.g., beam information, angles of transmission), spatial direction information of DL RS reception (e.g., beam ID used to receive DL RS, angle of arrival). “ID” may be used interchangeably with “index.” Examples of UL-RS include SRS and SRS for positioning purposes.

Example measurements are considered herein. In examples, a WTRU may measure a channel impulse response (CIR). A channel impulse response, consisting of N paths, may be defined by the following equation

$$h ( t ) = {\sum }_{k = 1}^{N} {h}_{k} ( t ) δ ( t - {τ}_{k} )$$

where hₖ(t) and τₖ are time-varying complex valued coefficient (e.g., expressed by a+bj where j=\sqrt{−1} for the channel impulse response and delay, measured in seconds, for the k^{th}path, respectively). The delta function is defined as δ(t)=1 for t=0 and δ(t)=0 for t≠0.

For simplicity, the coefficients may be assumed to be constant over time (e.g., hₖ(t)=hₖ). The WTRU may report hₖ and τₖ for each path k to the network. The WTRU may report the number of paths, N, to the network. Additionally, or alternatively, the WTRU may receive hₖ and τₖ for each path k, and/or the number of paths, from the network.

In examples, the WTRU may obtain a CIR from the network. The network may indicate DL-RS configuration(s) such as DL-RS resource IDs associated with the CIR. For example, the CIR may be associated with DL-RS resource ID. In this case, the WTRU may determine that the CIR is derived based on the measurements made on the DL-RS resource associated with the ID. Additionally, or alternatively, the WTRU may determine that the channel along the direction of transmission of the DL-RS or reception of the DL-RS corresponds to the CIR.

In examples, the CIR may be associated with a TRP ID. In this case, the WTRU may determine that the CIR represents the channel between the associated TRP and WTRU. In examples, the CIR may be associated with more than one TRPs where the network may include TRP indices associated with the CIR.

In examples, the CIR may be associated with a cell. In this case, the WTRU may receive cell ID or index associated with the CIR from the network.

In examples, the CIR may be associated with one or more than one TRPs or DL-RS resource IDs. In this case, the WTRU may determine that the channel between the TRPs and the WTRU corresponds to the CIR. Additionally, or alternatively, the WTRU may determine that the channel along the transmission directions of DL-RSs associated with IDs or reception directions of the DL-RS correspond to the CIR.

In examples, one or more than one CIRs may be associated with one parameter from DL-RS configurations (e.g., TRP ID, DL-RS resource ID, frequency layer ID). For example, the WTRU may receive information related to 2 CIRs associated with a TRP from the network,

$$( e . g . , {h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} ) )$$

from the network.

Additionally, or alternatively, the WTRU may report information related to one or more than one CIRs associated with DL-RS configuration (e.g., TRP ID, DL-RS resource ID) based on the measurements to the network. There can be more than one CIRs associated with DL-RS configuration, since the WTRU or network may observe different channel characteristics based on AoA of DL RS or UL RS, for example.

CIR may be represented by delay profile (DP) or power delay profile (PDP). A power delay profile may be defined as a set of delays and power profiles, such as [τ₀, τ₁, . . . , τ_{N-1}] and [p₀, p₁, . . . , p_{N-1}], where pₖ corresponds to relative power at the k^{th} path compared to the first path. A delay profile may be defined as a set of delays [τ₀, τ₁, . . . , τ_{N-1}] which indicates path delay for each path above p_{threshold}. The WTRU may receive p_{threshold} from the network to derive delay profile from power delay profile.

In examples, the channel impulse response the WTRU reports to the network may be defined by configured number of samples (e.g., N) where the WTRU is configured with a granularity of samples (e.g., X seconds apart). The WTRU may report samples whose RSRP is over the configured threshold or M highest RSRP among the samples. The WTRU may indicate locations or sample indexes of samples where the WTRU measures M highest RSRP samples. The first sample may be defined as the earliest arriving path (e.g., first path). The WTRU may report timing, phase, and/or power information per sample.

In examples, the WTRU may receive an indication from the network on how to generate CIR, PDP or DP based on timing, phase, and/or power measurements. The WTRU may send a request to the network to receive an indication on which methodologies to use to generate CIR, PDP or DP based on the measurements the WTRU made. For example, the WTRU may receive a message from the network (e.g., via LPP, RRC, MAC-CE, DCI) indicating the DL-RS resource indices and/or associated measurement type(s) (e.g., RSTD, AOA) to use to generate CIR, PDP, or DP. The WTRU may receive an indication from the network indicating to generate CIR, PDP, or DP.

In examples, the WTRU may receive a threshold (e.g., power threshold) from the network. The WTRU may receive, from the network, a timing range (e.g., 0 μs to 1 μs), and/or a timing granularity (e.g., every 0.1 μs in the indicated timing range, 100 sample points in the indicated timing range) of CIR, PDP, and/or DP. The WTRU may determine to report power and timing (e.g., relative timing compared to a reference timing, absolute timing) for samples whose received power is over the threshold.

The WTRU may send measurements in a report to the network (e.g., LMF, gNB) via a semi-static (e.g., LPP, RRC) or dynamic message (e.g., UCI, UL MAC-CE). Herein, DL-RS (e.g., CSI-RS, DM-RS, TRS) and SSB may be used interchangeably.

Artificial Intelligence (AI) for positioning is considered herein. Artificial intelligence may be broadly defined as the behavior exhibited by machines that mimics cognitive functions to sense, reason, adapt, act, and providing the ability to discern patterns.

Inputs and outputs used in AI for positioning are considered herein.

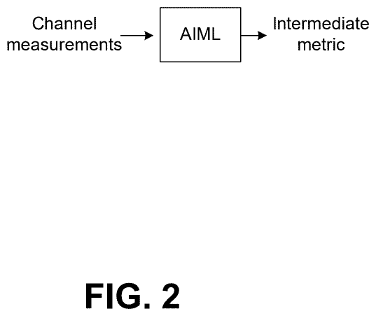

An example of using an AIML model to obtain WTRU location is shown in FIG. 2. As shown in FIG. 2, the WTRU may use channel measurements (e.g., timing, phase, power measurements such as RSTD, time of flight, ToA, ToD, carrier phase measurement, carrier phase difference measurement, RSRP, RSRP per path) as input the AIML model. The WTRU may obtain an inference (e.g., intermediate metric) from the AIML model. Examples of intermediate metrics include timing measurements or LOS indicators. The output of the AIML model may be referred to as an “inference.”

Measurements (e.g., measurements made on the received PRS or SRS) made by a WTRU, a PRU, and/or a TRP may be used as inputs and/or targets (e.g., ground truth) to train an AIML model. For example, PRS measurements may be used as training inputs, and associated LOS indicators may be used as a ground truth for training purposes. Performing and processing PRS and/or SRS measurements may be included in the preprocessing of training data for training an AIML model. The trained AIML model may be used to generate/predict/infer LOS indicators. If the AIML model is associated with or trained with measurements from more than one TRPs (e.g., and the WTRU has an AIML model), the WTRU may use measurements made from more than one TRPs as inputs to the AIML model. The WTRU may receive an indication or configuration from the network for the AIML model. The configuration may comprise information about identification information about the TRPs (e.g., TRP IDs, PRS IDs) the AIML model is trained with (e.g., if the AIML model is trained with measurements from more than one TRP). In one example, the WTRU may receive a request or indication from the network (e.g., LMF, gNB) to use PRS and/or SRS measurements as an input for the AIML model at the WTRU. In another example, the WTRU may indicate to the network that PRS and/or SRS measurements are used as an input for the AIML model at the WTRU. The indication from the WTRU or request from the network may include details (e.g., configurations for PRS or SRS) of the measurements to be used as an AIML model input. In the examples described here in, “AIML” and “AI/ML” can be used interchangeably.

Examples of inputs for an AIML model for positioning may include one or more (e.g., any combination) of the following: RSRP of PRS resource(s); statistical measures of RSRP (e.g., mean, variance etc.) per PRS resource(s); maximum or minimum values of RSRP per PRS resource(s); RSRP of PRS resource(s) per path;

RSRP of PRS resource(s) per antenna port; RSCP of PRS resource(s) per path;

RSCP of PRS resource(s) per antenna port; reference signal timing difference (RSTD) and/or reference signal carrier phase difference (RSCPD) of PRS resource(s); statistical measures of RSTD per PRS resource(s); maximum or minimum value of RSTD per PRS resource(s); RSTD and/or RSCPD of PRS resource(s) per path; RSTD and/or RSCPD of PRS resource(s) per antenna port; times of arrival per PRS resource(s); times of arrival per PRS resource(s) per path; times of arrival per PRS resource(s) per port; statistical measures of times of arrival per PRS resource(s); maximum or minimum value of times of arrival per PRS resource(s); CIR estimated based on DL-RS(s) (e.g., PRS, CSI-RS, DM-RS), where CIR may be associated with a TRP or TRPs; PDP estimated based on DL-RS(s) (e.g., PRS, CSI-RS, DM-RS), where CIR may be associated with a TRP or TRPs; and/or DP estimated based on DL-RS(s) (e.g., PRS, CSI-RS, DM-RS), where CIR may be associated with a TRP or TRPs.

A WTRU's AIML model can infer an LOS/NLOS indicator or timing information. The WTRU may need to train AIML models with ground truths and associated measurements.

The WTRU may need the ground truth for the intermediate metric to train the AIML model(s) at the WTRU. However, the WTRU may not be able to determine an accurate intermediate metric (e.g., LOS/NLOS indicator) based on the PRS measurements due to a lack of (e.g., an insufficient quantity of) measurements. This can cause the quality of the LOS indicator estimate, obtained based on PRS measurements, to not be good enough to be used as the ground truth.

The WTRU may receive a request to determine LOS indicator (e.g., hard, such as 1 or 0, or soft, such as 0.1, 0.2, etc.) for a WTRU-TRP pair. The WTRU may receive PRS and make measurements.

The WTRU may send a request to a network entity (e.g., to the LMF) for SRS information. The SRS information may include preferred SRS configurations (e.g., spatial relationship with respect to PRS) and/or corresponding SRS measurements. The SRS information may also include a timestamp associated with the corresponding SRS measurements.

The WTRU may receive SRS information, for example, including the configurations for SRS. The WTRU may transmit the SRS according to the received configuration.

The WTRU may receive (e.g., in the SRS information) SRS measurements from the network entity (e.g., LMF or gNB) and associated timestamp(s).

The WTRU may determine to use an SRS measurement if the difference between a timestamp of the PRS measurement and the timestamp associated with the SRS measurement is less than a configured threshold.

The WTRU may determine the LOS indicator for the WTRU-TRP pair and associated quality indicator using the PRS measurements and/or the SRS information/measurements. In examples, if the WTRU uses both SRS measurements and PRS measurements to determine the LOS indicator, the WTRU may set the associated quality indicator to a maximum value (e.g., 1). In examples, if PRS measurements (e.g., only PRS measurements) are used to determine the LOS indicator, the WTRU may determine the associated quality indicator based on the quality of measurements, and the associated quality indicator may be less than the maximum value (e.g., less than 1).

The WTRU may send a report (e.g., to the network entity). The report may indicate the determined LOS indicator, associated quality indicator and/or (e.g., optionally) PRS measurement.

A WTRU may be configured to support WTRU-based LOS indicator determination.

Details relating to PRS reception are discussed herein. In examples, the WTRU may receive a request from the network to perform LOS determination. Herein, an LOS indicator is used as an example of an intermediate metric. However, the examples discussed herein are not limited to using the LOS indicator as the intermediate metric. The examples discussed herein are equally applicable to other types of intermediate metrics (e.g., timing measurement, timing information, etc.).

The WTRU may receive a request to determine an LOS status for indicated PRS resource(s) and/or TRP(s). The WTRU may receive PRS configuration information from the network (e.g., LMF, gNB). The WTRU may receive one or more PRSs. The WTRU may make measurements on the received PRS(s).

A WTRU may send a request for SRS configuration information. In examples, the WTRU may send a request to the network for SRS information, wherein the SRS information includes SRS measurements. Separately or together, the WTRU may send, to the network, a request for SRS information that includes one or more SRS configurations. Once the WTRU receives the SRS configuration(s) from the network, the WTRU may transmit the configured SRS. The WTRU can receive, from the network, corresponding SRS measurements.

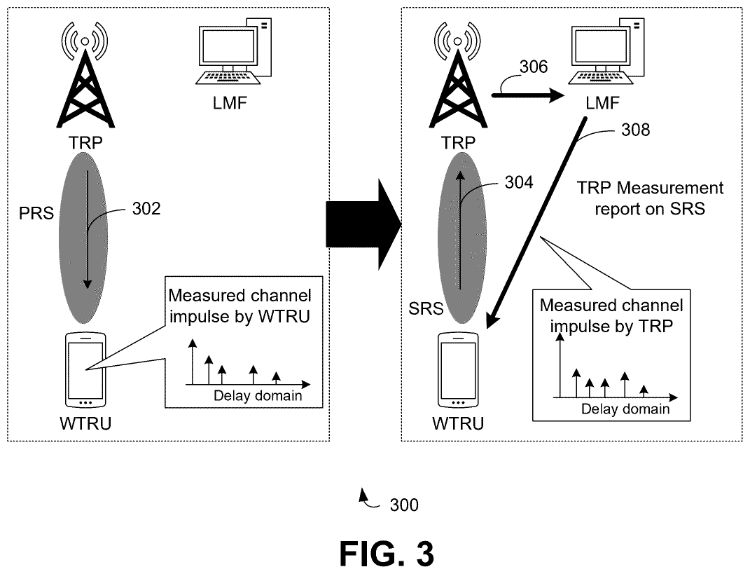

An example is illustrated in FIG. 3 at 300. In the example, the WTRU receives PRS from the network and makes measurements at 302. The WTRU transmits the configured SRS to the network at 304. The network measures the SRS and provides the measurements to the LMF at 306. The WTRU receives SRS measurements, made by the network, from the LMF at 308. Based on the PRS measurements and SRS measurements, the WTRU can determine the LOS/NLOS indicator for the channel.

In examples, the request for SRS configurations may include one or both of the described parameters. The request for SRS configurations may comprise one or more desired SRS configuration(s) (e.g., spatial direction, spatial information, periodicity, number of symbols, repetition factors, bandwidth). The request for SRS configurations may comprise an absolute time or relative time which indicates the desired timing at which SRS configuration should be activated.

In examples, the WTRU may receive an activation or deactivation command for the requested SRS configuration. The WTRU may receive the activation and/or deactivation command via a dynamic message (e.g., DCI, MAC-CE). The WTRU may receive a request to transmit SRS at configured periodicity after the WTRU receives the activation command. The WTRU may stop transmission of SRS when the WTRU receives the deactivation command.

The WTRU may send a request to the network for activation or deactivation. In another example, the WTRU may receive a semi-static message (e.g., via RRC, LPP message) to initiate SRS transmission. The WTRU may receive a time window during which the WTRU transmits SRS at the configured periodicity. The WTRU may receive parameters for the time window (e.g., duration, start time, end time, where time may be expressed in terms of absolute time, system time, SFN, frame/subframe index, symbol index, slot index, or another time unit).

In examples, the WTRU may be configured with spatial information for SRS. The spatial information for the SRS may be associated with the configured PRS. When the WTRU sends a request for SRS transmission, the WTRU may indicate one of the configured PRS. This may indicate to the network that the SRS will be transmitted along the transmission or reception direction of the indicated PRS.

Requests for SRS configurations may be conditionally triggered. In examples, the WTRU may receive, from the network, the conditions based on which the request for SRS configurations is triggered. The WTRU may send a request for SRS configuration(s) based on any one or any combination of the following conditions. The WTRU may send a request for SRS configurations based on an RSRP or RSRP per path in multipath measurements being below the configured threshold. The WTRU may send a request for SRS configurations based on an uncertainty associated with the PRS measurement (e.g., timing, power) being above a configured threshold. Uncertainty may be range of measurements or a statistical metric (e.g., standard deviation, variance). The WTRU may send a request for SRS configurations based on a confidence indicator for the LOS indicator determined based on PRS measurement being below a configured threshold. The WTRU may send a request for SRS configurations based on the WTRU receiving a grant, from the network, for sending a request for SRS configurations. The WTRU may send a request for SRS configurations based on the WTRU being configured, by the network, to send a request for SRS configuration. The WTRU may send a request for SRS configurations based on the WTRU being configured with a positioning method that requires SRS transmission. Examples of such positioning methods include multi RTT positioning method, UL-TDOA, UL-AoA, etc.

A WTRU may be configured with various potential positioning methods. In examples, the WTRU may be configured with a positioning method. The WTRU may be configured with DL, UL, and/or DL & UL positioning method. In examples, the WTRU may receive a request from the network to report the LOS indicator. In examples, the WTRU may receive a request to use an AIML model(s) to generate the LOS indicator. The WTRU may be configured with a positioning method that requires timing measurements (e.g., DL-TDOA, multi-RTT). The WTRU may receive a request to report the LOS indicator along with the timing measurements.

A WTRU may send a request for SRS measurements. In examples, the WTRU may request for measurements for one or more indicated SRSs. For example, the WTRU may indicate one or more SRSs by including a preferred range in the time domain for the measurements in the request. The preferred range may be indicated by duration, start and/or end time. The duration may be expressed in terms of the number of symbols, slots, etc.

The request for measurements may include at least one of the following parameters. The request for measurements may include a desired time range for the measurements. The request for measurements may include a desired periodicity of measurements. The request for measurements may include a desired processing (e.g., averaged measurements across occasions or measurements per occasion). In examples, one occasion may correspond to one transmission instance of SRS. Periodic SRS transmission may include one or more than one instances of SRS transmission). The request for measurements may include a desired type of measurement (e.g., timing, power, phase, RTOA, RSTD, gNB Rx-Tx time difference). The request for measurements may include a desired periodicity of measurement delivery. The request for measurements may include an indication of the WTRU's location.

Activation or deactivation are discussed herein. Based on the SRS measurements the WTRU may determine LOS status of the channel. The WTRU may send a request which includes desired SRS configurations (e.g., desired SRS spatial information, repetition factor, BWP). In examples, the desired SRS spatial information (e.g., direction or angle of transmitted SRS) may be aligned spatially with the received PRS. In another example, the WTRU may send a request which includes desired frequency resources (e.g., BWP, carrier frequency, band number, carrier component ID, frequency layer ID) at which the SRS is transmitted.

SRS measurements and associated information are discussed herein. In examples, the WTRU may receive SRS measurements from the network (e.g., LMF, gNB). The SRS measurements may comprise timing measurements (e.g., received ToA, RSTD, gNB Rx-Tx), power measurements (e.g., RSRP, RSRP per path, RSRP per sample) and/or phase measurements (e.g., RSCP, RSCPD).

The received SRS measurements may be associated with at least one of the following parameters or values. The received SRS measurements may be associated with SRS configurations (e.g., SRS resource ID, bandwidth, transmission power). The received SRS measurements may be associated with a timestamp that is associated with the SRS measurement. The received SRS measurements may be associated with a WTRU ID or any identification information related to the WTRU which transmitted the SRS. The received SRS measurements may be associated with a location (e.g., absolute location, relative location relative to an indicated reference location, zone, cell ID, area ID) at which the SRS was transmitted from. The received SRS measurements may be associated with a LOS/NLOS indicator determined by the network based on the measurements made on the SRS.

In examples, the WTRU may determine to use the SRS measurement to determine the LOS status if the time difference between timestamp of the PRS measurement made by the WTRU and that of SRS measurement is less than the configured threshold.

In examples, the WTRU may determine the timestamp for the PRS measurement based on the time the WTRU makes measurements or receive PRS from the network. In examples, the WTRU may determine the timestamp for the PRS measurement based on the time the WTRU reports the PRS measurements to the network.

In examples, the timestamp may correspond to the time when the WTRU made a PRS measurement. For example, the timestamp associated with the SRS measurement may correspond to the time when the network made measurements on the received SRS. The timestamp associated with the SRS measurement may correspond to the time when the WTRU received the SRS measurement from the network.

The WTRU may use information to determine an LOS indicator.

In one example, the WTRU may determine the LOS indicator based on one or more of the following parameters or values: PRS measurements (e.g., power, timing, phase measurements), and/or SRS measurements (e.g., power timing phase measurements).

The WTRU may receive, from the network, configuration information for PRS. The WTRU may also receive, from the network, a request to determine and/or report the LOS indicator for an indicated PRS (e.g., indicated via a PRS resource ID). The WTRU may determine to use measurements made on the indicated PRS. The WTRU may determine to use SRS measurements that have a spatial relationship or QCL relationship with the indicated PRS (e.g., SRS is transmitted along the same direction from which the WTRU received the PRS).

The WTRU may receive an indication from the network to determine and/or report the LOS indicator for an indicated TRP. The WTRU may need to determine the LOS status between the WTRU and TRP. To determine the LOS indicator, the WTRU may determine to use the measurements corresponding to the configured PRSs transmitted from the indicated TRP. The WTRU may receive an indication from the network of which PRSs to measure to determine the LOS indicator.

The WTRU may report the PRS measurements used to determine the LOS indicator. The WTRU may also report an ID or index corresponding to the PRS (e.g., via PRS resource ID). The WTRU may determine to use SRS measurements corresponding to the SRS transmitted toward the indicated TRP. The WTRU may receive an indication from the network of which SRS measurements to use (e.g., via SRS resource ID) to determine the LOS indicator.

In examples, the WTRU may report the SRS measurements used to determine the LOS indicator. The WTRU may also report an ID or index corresponding to the SRS (e.g., via SRS resource ID).

The WTRU may determine a quality indicator for the LOS indicator. In examples, the WTRU may determine the LOS indicator for the indicated TRP or PRS resource and an associated quality indicator. The quality indicator may be an indication of confidence in the estimate of the LOS/NLOS indicator. For example, if the LOS/NLOS indicator is a hard indicator with a value of 1 or 0, the quality indicator may be a soft indicator with a value between 0 and 1 (e.g., 0.5, 0.9), or between 0 and 100 (e.g., 50, 99), etc. The WTRU may determine the quality indicator based on one or more of the examples.

If both SRS measurement and PRS measurement are used to determine the LOS indicator, the associated quality indicator may be 1 (e.g., a hard indicator), where the maximum value of the quality indicator is 1. If PRS measurements or SRS measurements (e.g., only PRS measurements or SRS measurements) are used to determine the LOS indicator, the associated quality indicator may be determined based on the quality of measurements. The LOS indicator may be a soft indicator and may be less than 1, where the maximum value of the quality indicator is 1. If both SRS measurement and PRS measurement are used to determine the LOS indicator, the associated quality indicator may be less than 1 (e.g., a soft indicator). The WTRU may determine a value for the soft LOS indicator based on quality of measurements. If PRS measurements or SRS measurements (e.g., only PRS measurements or SRS measurements) are used to determine the LOS indicator, the associated quality indicator may be set to 0 (e.g., a hard indicator).

The WTRU may receive a request from the network (e.g., via RRC, LPP message) to report the LOS indicator and/or associated quality indicator. In one example, the WTRU may determine to report the quality indicator if the LOS indicator is a hard indicator (e.g., 1 for LOS, 0 for NLOS). The WTRU may receive, from the network, a request to report the quality indicator.

A WTRU may associate measurements with an LOS/NLOS indicator. In examples, the WTRU may determine to associate the LOS/NLOS indicator with measurements (e.g., timing, power, phase). Such association may enable the network to determine characteristics of the channel or reliability of measurements.

The WTRU may determine to associate one or more (e.g., any combination) of the following information: sample(s) from CIR, PDP, DP; path timing for path-based measurements; gNB Rx-Tx time difference measurement; WTRU Rx-Tx time difference measurement; RSTD; time of arrival; time of flight (ToF), where ToF may indicate the propagation time from the network (e.g., TRP) to WTRU; and/or angle of arrival, where the angle may be defined with respect to a reference direction.

The WTRU may indicate the measurement is independent of the LOS indicator or associated with the LOS indicator. In examples, ToF being associated with the LOS indicator may indicate ToF through LOS or NLOS. If the associated LOS indicator is 1, ToF may indicate the propagation time along the LOS path. In examples, the WTRU may determine virtual RSTD by computing ToF for two PRSs and determine the virtual RSTD based on the assumption that the two PRSs propagated through the LOS.

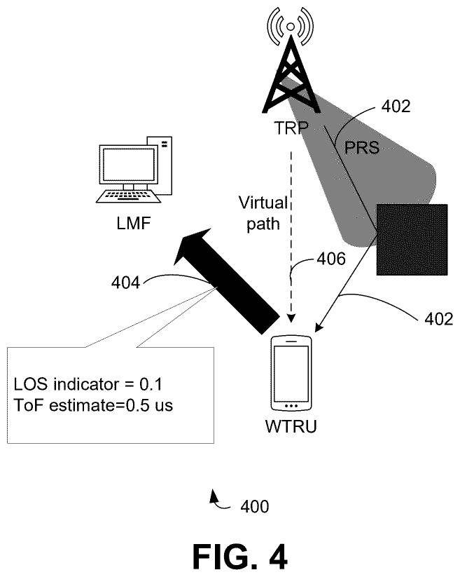

An example is shown in FIG. 4 at 400, where the WTRU receives PRS from the NLOS path. In the example, the TRP transmits PRS along a NLOS path 402. The WTRU may send a report 404, to the LMF, including the LOS indicator corresponding to the received PRS. The WTRU may also report ToF estimates along the LOS path (e.g., the virtual path 406 indicated in FIG. 4). The WTRU may determine the ToF based on PRS and/or SRS measurements.

The WTRU may indicate that the associated measurements were determined by the WTRU. For example, the WTRU may record ToA for PRS and time of transmission for SRS to determine the WTRU Rx-Tx time difference. The WTRU may record ToAs of PRSs received from the network and the WTRU may determine RSTD based on the ToAs.

WTRU reporting behavior is considered herein. A WTRU may receive a request to report measurements to the network. The WTRU may determine to report PRS measurements to the network based on the request. The WTRU may determine to indicate which SRS measurement(s) the WTRU used for determination of LOS/NLOS indicator(s). The WTRU may indicate, to the network, SRS configuration(s) associated with the SRS measurements (e.g., SRS resource index) the WTRU used to determine the LOS/NLOS indicator. In examples, the WTRU may indicate PRS measurements used to determine the LOS/NLOS indicator. The WTRU may report PRS configuration(s) associated with PRS measurements the WTRU used to determine the LOS/NLOS indicator. The WTRU may determine to associate SRS and/or PRS measurements if both measurements are used to determine the LOS/NLOS indicator. The WTRU may report the determined LOS/NLOS indicator to the network.

In examples, the WTRU may determine to request one or more than one SRSs (e.g., more than one SRS resources to transmit SRS). The WTRU may perform multiple transmissions of SRS in a sweep. The WTRU may receive, from the network, one or more than one PRSs. The WTRU may determine to associate one or more than one PRSs to one SRS; or associate one or more than one SRSs to one PRS, to determine to the LOS/NLOS indicator.

In one example, the WTRU may determine to report the association between SRS(s) and PRS(s) used to determine the LOS/NLOS indicator. For example, in the measurement report, the WTRU may indicate association between one SRS resource and more than one PRS resources to indicate to the network that corresponding PRS and SRS measurements are used to determine the LOS indicator. In another example, the WTRU may determine to associate one PRS resource to more than one SRS resources in the measurement report.

Examples illustrating signal exchanges are discussed herein.

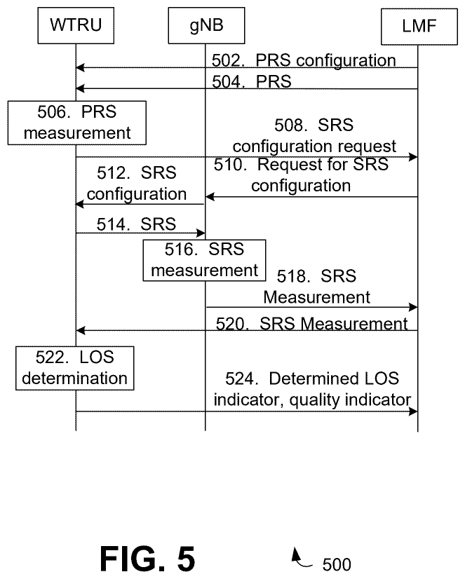

Exchange of signals between the WTRU and network (e.g., LMF, gNB) are shown in FIG. 5. At 502, the WTRU may receive PRS configuration(s) from the network. At 504, the WTRU may receive corresponding PRS(s) from the network. At 506, the WTRU may make measurements on the received PRS. At 508, the WTRU may send a request for SRS configuration to the LMF. At 510, the LMF may send a request for SRS configuration to the gNB. At 512, the WTRU may receive SRS configuration from the gNB. At 514, the WTRU may transmit configured the SRS to the gNB (e.g., TRPs). At 516, the gNB makes measurements of the SRS and transfer them to the LMF at 518. At 520, the WTRU may obtain SRS measurements from the LMF. At 522, the WTRU may determine the LOS indicator and/or an associated quality indicator. At 524, the WTRU may report the LOS indicator and/or associated quality indicator to the LMF.

In embodiments, the WTRU may receive a request to determine LOS indicator (e.g., hard, or soft) for a WTRU-TRP pair. The WTRU may receive PRS and make measurements. The WTRU may determine its location (e.g., using the PRS measurements).

The WTRU may send a request (e.g., to the LMF) for preferred SRS information. The SRS information may include configurations (e.g., having spatial relationships with respect to PRS) and/or corresponding SRS measurements (e.g., with an associated timestamp).

The WTRU may receive one or more configurations for SRS and transmits the SRS according to the received configurations. The WTRU may receive SRS measurements from a network entity (e.g., LMF or gNB). The SRS measurements may have an associated timestamp. The WTRU may determine to use the SRS measurements if the difference between timestamp of PRS measurement and SRS measurement is less than a configured threshold.

The WTRU may determine the LOS indicator for the WTRU-TRP pair and associated quality indicator as follows based on the SRS measurements and or the PRS measurements. If both SRS measurement and PRS measurement are used to determine the LOS indicator, the associated quality indicator may be set to a maximum value (e.g., 1). If PRS measurements (e.g., only PRS measurements) are used to determine the LOS indicator, the associated quality indicator may be determined based on the quality of measurements and may be less than the maximum value (e.g., 1).

The WTRU may report one or more of the determined LOS indicators, the associated quality indicator, and/or (e.g., optionally) the PRS measurement(s).

A WTRU may be configured to support PRU-assisted WTRU-based LOS indicator determination. The WTRU may determine to request SRS information. The requested SRS information may include measurements corresponding to the SRS transmitted by PRU.

Details related to the request for SRS information are considered herein. The WTRU may include various information in a request for triggering the transmission of SRS. In examples, the WTRU may determine to request the network to trigger transmission of SRS from other WTRU(s) or PRU(s). The WTRU may determine to include one or more (e.g., any combination) of the following information in the request.

The request may include a timing (e.g., start time) of one or more SRS transmission(s) by another PRU or WTRU. This timing may be absolute time or relative time (e.g., 10 ms from the time when the WTRU sent the request to the network). The timing can be timing of aperiodic or one-shot SRS transmission, or the start of the periodic or semi-static SRS transmission (e.g., SRS is transmitted periodically during a configured time window and the requested timing may be the start time of the window or start time of transmission of SRS). The request may include parameters for a time window during which SRS can be transmitted by a PRU or WTRU.

The request may include a location or area (e.g., cell ID, zone ID, serving cell where the WTRU is located) to which the SRS should be transmitted. The request may include cell IDs. The cell IDs may indicate to which a PRU or WTRU should transmit SRS.

The request may include preferred SRS configurations (e.g., spatial information, bandwidth, SRS resource ID, periodicity, IDs of TRPs to which a PRU or WTRU should transmit SRS). The request may include a type of SRS transmission (e.g., periodic, semi-persistent, aperiodic).

The request may include a (e.g., requested) type of WTRU which transmits the SRS (e.g., PRU, non-PRU WTRU, reduced capability WTRU, WTRU or PRU with the same capability as the WTRU). The request may include identification information of WTRU or PRU. The identification information may include WTRU ID, PRU ID, Application layer ID, and/or any ID that is determined at the application layer. The request may include a (e.g., requested) number of PRUs or WTRUs to transmit SRS. The request may include a (e.g., requested) distribution of PRUs or WTRUs to transmit SRS (e.g., one PRU per cell, one PRU per zone, N PRUs per cell where N is an integer). The request may include a WTRU location (e.g., a location of the requesting WTRU).

In examples, the request may indicate a request for a certain number of PRUs to transmit per zone. A zone may be defined by a predefined area. The zone may be situated within a cell or may encompass more than one cells. A zone may be identified by geographical coordinates.

A WTRU may be configured for choosing PRUs or WTRUs to request to transmit SRS. In examples, the WTRU may receive a list of WTRUs or PRUs. The list of WTRUs or PRUs may contain at least one or combination of the following information: identification information of the WTRUs and/or PRUs; location information (e.g., absolute location, relative location with respect to a reference location) of the WTRUs and/or PRUs; area information (e.g., cell ID or zone) about the area the WTRUs and/or PRUs are located in; and/or capability information of the WTRUs and/or PRUs (e.g., types of SRS the PRU can transmit).

In the list, each WTRU or PRU may be identified by an index. The WTRU may send the network preferred indices of WTRUs or PRUs which may transmit SRS to the network.

The WTRU may include various information in the request for SRS information (e.g., measurements corresponding to the SRS transmitted by PRU). In examples, the WTRU may determine to include one or more (e.g., any combination) of the following information in the request for SRS measurements. The request for SRS measurements may include a request for SRS measurements from PRU or WTRU; a request for PRS measurements from PRU or WTRU; an indication of preferred PRS configurations (e.g., spatial information, bandwidth, PRS resource ID, TRP ID) which the measurements are associated with; an indication of preferred SRS configurations (e.g., spatial information bandwidth, SRS resource ID); the location (e.g., absolute, relative position) of the WTRU; and or an indication of method(s) used to determine the location of the WTRU (e.g., GNSS, RAT dependent positioning).

The WTRU may receive assistance data for SRS measurements. In examples, the WTRU may receive SRS measurements corresponding to the SRS transmitted by another PRU or WTRU. The SRS measurements may be accompanied by assistance information comprising one or more (e.g., any combination) of the following information.

The assistance information may include SRS configurations associated with the measurement. The assistance information may include a location of transmission (e.g., absolute location, relative location). The assistance information may include a WTRU or PRU ID (e.g., index). The assistance information may include a location of the WTRU or PRU (e.g., absolute location, relative location, cell ID). The location may indicate where the measurements were performed. The assistance information may include an area from which SRS is transmitted. The assistance information may include a timestamp indicating, for example, time at which SRS is transmitted, or when SRS was measured by the network. The assistance information may include a LOS indicator determined by the WTRU or PRU which transmitted the SRS and optionally associated quality indicator. The assistance information may include a LOS indicator determined by the LMF and optionally associated quality indicator.

The WTRU may perform processing and reporting in connection with the examples described herein.

The WTRU may use positioning method(s) determine its location. In examples, the WTRU may determine its location based on positioning method(s) (e.g., RAT dependent positioning method, or RAT independent positioning method). The WTRU may report the determined location to the network (e.g., LMF). For example, the WTRU may report the determined location if it is requested by the network. The WTRU may indicate the positioning method used to determine the location (e.g., in the same report as the determined location).

A request for SRS transmission or SRS measurements from different WTRUs/PRUs may be sent based on the occurrence of one or more conditions. In examples, the WTRU may determine to send a request for SRS transmissions from different PRUs or WTRUs based on one or both of the following conditions.

A first exemplary condition may occur if a timestamp associated with an SRS measurement corresponding to the SRS transmitted by the WTRU and PRS measurement is greater than a configured threshold. A second exemplary condition may occur if a quality of an SRS measurement or PRS measurement is below a configured threshold. Examples of quality include RSRP, range of measurements, or a statistical parameter (e.g., standard deviation, variance). The occurrence of one or both of these conditions, or other conditions, may trigger the WTRU to request SRS transmission or measurements from different WTRUs/PRUs.

The WTRU may include various information in a report associated with a determined LOS indicator. In examples, the WTRU may determine to report the measurements used to determine the LOS indicator. The WTRU may report SRS measurements and/or PRS measurements used to determine the indicator. The WTRU may report one or more (e.g., any combination) of the following to the network: a LOS indicator; PRS or SRS configuration(s) associated with measurements used to determine the LOS indicator; PRS measurements used to determine the LOS indicator; SRS measurements used to determine the LOS indicator; WTRU or PRU ID corresponding to the measurements used to determine the LOS indicator; area or location information corresponding to the measurements used to determine the LOS indicator; a quality indicator for the determined LOS indicator; and/or a timestamp.

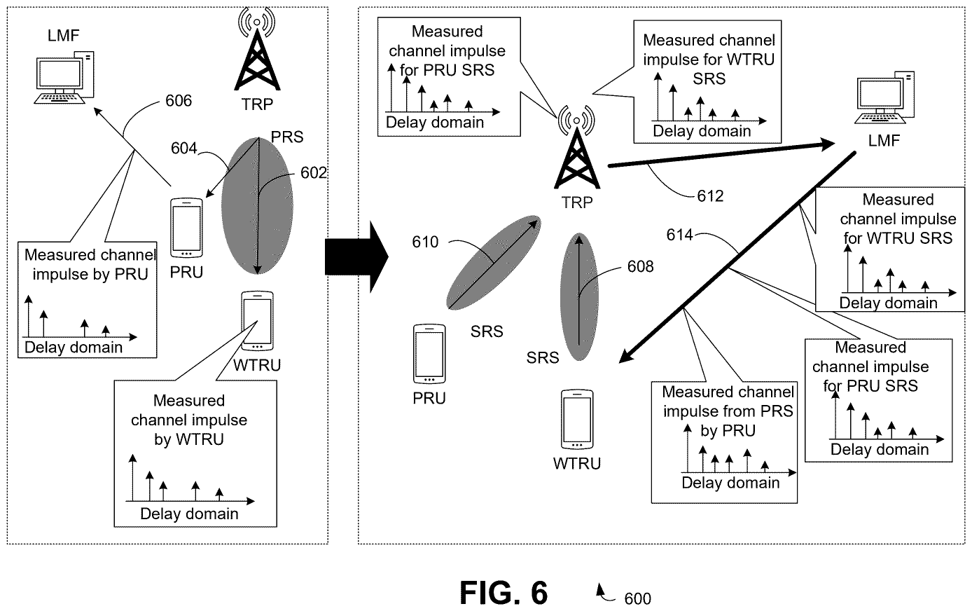

An illustrative example of signal exchange concerning LOS determination is shown in FIG. 6. As shown in the figure, one or both of a WTRU (e.g., at 602) and a PRU (e.g., at 604) may make measurements on a received PRS from the network. The WTRU and PRU may make measurements on different PRSs (e.g., PRS resources). The PRU may report PRS measurements to the network at 606. One or both WTRU (e.g., at 608) and PRU (e.g., at 610) may be configured to transmit SRS to the network. The WTRU may send a request, to the network, for SRS measurements and/or PRU measurements. The network may measure the SRS from the PRU and/or WTRU at 612. The WTRU may receive measurements from the network (e.g., LMF) at 614. The WTRU may receive, from the network, measurements corresponding to the SRS the WTRU transmitted at 614. The WTRU may receive measurements corresponding to the PRS received by the PRU at 614. The WTRU may receive measurements corresponding to the SRS transmitted by the PRU at 614.

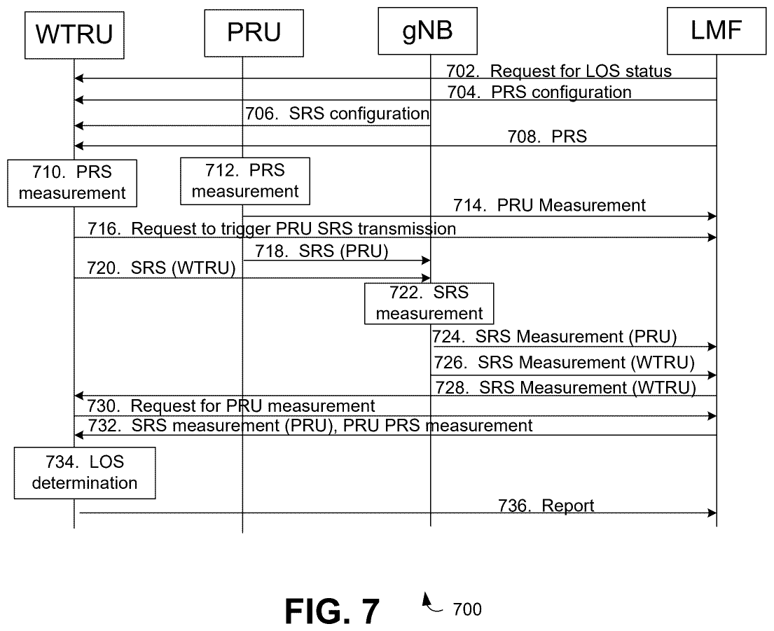

An example of an exchange of signals between a, WTRU, PRU, gNB and an LMF is shown in FIG. 7. At 702, the WTRU may receive a request from the LMF to determine the LOS indicator between WTRU and the indicated TRP.

At 704, the WTRU may receive PRS configurations from the LMF. At 706, the WTRU may receive the SRS configurations from the gNB. At 708, the WTRU may receive PRS from the network. The WTRU (e.g., at 710) and PRU (e.g., at 712) may make measurements on the received PRS. At 714, the PRU may report measurements to the LMF.

At 716, the WTRU may send a request to the network for SRS transmission from another PRU. The PRU (e.g., at 718) and/or WTRU (e.g., at 720) may transmit SRS to the network. At 722, the gNB make measure the SRSs sent by the WTRU and/or PRU. At 724, the gNB may report SRS measurements made on the SRSs transmitted by the PRU (e.g., at 724) and/or WTRU (e.g., at 726). At 728, the WTRU may receive, from the LMF, SRS measurements made by the gNB for the SRS transmitted by the WTRU.

At 730, the WTRU may send a request for PRU measurements to the LMF. At 732, the WTRU may receive, from the LMF, PRU measurements made by the PRU. The WTRU may also (e.g., in the same transmission) receive SRS measurements corresponding to the SRS transmitted by the PRU.

At 734, the WTRU may determine LOS status between WTRU and the indicated TRP. At 736, the WTRU may report the determined LOS status to the LMF. The WTRU may report measurements used to determine the LOS status to the LMF.

In embodiments, the WTRU may receive a request to determine a LOS indicator (e.g., hard or soft) for a WTRU-TRP pair. The WTRU may receive a PRS and makes measurements. The WTRU may determine its location based on the PRU measurement. The WTRU may send a request, to the LMF, for preferred SRS configurations and SRS measurements, and/or to trigger PRUs to transmit indicated SRS (e.g., or SRSs that are aligned with indicated PRS).

The WTRU may receive configurations for SRS and transmit the SRS according to the received configuration. The WTRU may receive, from the LMF, SRS measurements and/or an associated timestamp for the SRS transmitted by the WTRU. The WTRU may receive, from the LMF, SRS measurement and/or associated timestamps for the SRS transmitted by the PRU, location of the PRU, assistance data related to the SRS (e.g., spatial relationship). The WTRU may receive, from the LMF, PRS measurements and/or associated timestamps for the PRS received by the PRU. The WTRU may also receive the location of the PRU, and/or assistance data related to PRS (e.g., spatial relationship information).

The WTRU may report, to the network, the determined LOS indicator, associated quality indicator, and/or (e.g., optionally) PRS measurements. Using the embodiments described herein, the WTRU may obtain measurements to determine an LOS indicator with high reliability.

1. A wireless transmit/receive unit (WTRU) comprising a processor configured to:
receive a positioning reference signal (PRS);
send a request for sounding reference signal (SRS) information to a network entity, wherein the request for SRS information indicates a request for an SRS configuration and corresponding SRS measurements;
receive the SRS information;
determine a line-of-sight (LOS) indicator, based on one or both of the PRS and the SRS information;
determine a quality associated with the LOS indicator; and
send a report comprising the LOS indicator and an indication of the quality associated with the LOS indicator.

2. The WTRU of claim 1, wherein the SRS information further comprises a timestamp, and wherein the processor is configured to:
determine to use the SRS measurements comprised in the SRS information, if the difference between the timestamp comprised in the SRS information and a timestamp associated with the PRS is less than a threshold.

3. The WTRU of claim 1, wherein the processor is configured to:
determine the LOS indicator based on both the SRS information and the PRS.

4. The WTRU of claim 3, wherein the processor is configured to:
determine the quality associated with the LOS indicator to be a maximum value.

5. The WTRU of claim 1, wherein the processor is configured to:
determine the LOS indicator based on the PRS, but not based on the SRS information.

6. The WTRU of claim 5, wherein the processor is configured to:
determine the quality associated with the LOS indicator to be less than a maximum value.

7. The WTRU of claim 1, wherein the report further comprises an indication of one or more measurements of the PRS.

8. The WTRU of claim 1, wherein the processor is configured to:
obtain or configure the one or more measurements of the PRS as training data during a preprocessing phase for an artificial intelligence or machine learning (AIML) model.

9. The WTRU of claim 1, wherein the processor is configured to:
receive a request to determine the LOS indicator.

10. The WTRU of claim 1, wherein the report further comprises an indication of one or more of the SRS measurements indicated in the SRS information.

11. A method to be performed by a wireless transmit/receive unit (WTRU), the method comprising:
receiving a positioning reference signal (PRS);
sending a request for sounding reference signal (SRS) information to a network entity, wherein the request for SRS information indicates a request for an SRS configuration and corresponding SRS measurements;
receiving the SRS information;
determining a line-of-sight (LOS) indicator, based on one or both of the PRS and the SRS information;
determining a quality associated with the LOS indicator; and
sending a report comprising the LOS indicator and an indication of the quality associated with the LOS indicator.

12. The method of claim 11, wherein the SRS information further comprises a timestamp, the method further comprising:
determining to use the SRS measurements comprised in the SRS information, if the difference between the timestamp comprised in the SRS information and a timestamp associated with the PRS is less than a threshold.

13. The method of claim 11, further comprising:
determining the LOS indicator based on both the SRS information and the PRS.

14. The method of claim 13, further comprising:
determining the quality associated with the LOS indicator to be a maximum value.

15. The method of claim 11, further comprising:
determining the LOS indicator based on the PRS, but not based on the SRS information.

16. The method of claim 15, further comprising:
determining the quality associated with the LOS indicator to be less than a maximum value.

17. The method of claim 11, wherein the report further comprises an indication of one or more measurements of the PRS.

18. The method of claim 11, further comprising:
obtaining or configuring the one or more measurements of the PRS as training data during a preprocessing phase for an artificial intelligence or machine learning (AIML) model.

19. The method of claim 11, further comprising:
receiving a request to determine the LOS indicator.

20. The method of claim 11, wherein the report further comprises an indication of one or more of the SRS measurements indicated in the SRS information.
